(19) United States
(12) Patent Application Publication
(10) Pub. No.: US 2016/0337673 A1
(43) Pub. Date: Nov. 17, 2016

(54) PROTECTION OF PRIVACY IN A VIDEO STREAM BY MEANS OF A REDUNDANT SLICE

(71) Applicant: SIEMENS AKTIENGESELLSCHAFT, MÜNCHEN (DE)

(72) Inventors: BERNHARD AGTHE, LANDSBERG AM LECH (DE); GERO BÄSE, MÜNCHEN (DE)

(21) Appl. No.: 15/181,445

(22) PCT Filed: Oct. 21, 2014
(86) PCT No.: PCT/EP2014/072561

§ 371 Date: Jun. 14, 2016

(30) Foreign Application Priority Data
Dec. 20, 2013 (DE) 10 2013 226 802.5

(51) Int. Cl. H04N 21/2347; H04N 21/2343; G06F 21/60; H04N 19/48; G06F 21/62; H04L 29/06; H04N 21/431

(52) U.S. Cl. CPC H04N 21/23476; H04L 65/601; H04N 21/234345; H04N 21/4318; H04N 19/48; G06F 21/6245; G06F 21/602

(57) ABSTRACT

In order to protect data privacy in a video stream, a video stream is provided which includes a slice structure. A video stream slice includes content that is to be protected is identified. A slice which is at least partially redundant in relation to the identified slice is created. The content to be protected in one of the two slices is encrypted. At least one measure for assuring data privacy is used on the content to be protected in the other of the two slices.

### CROSS-REFERENCE TO RELATED APPLICATIONS

This application claims priority to PCT Application No. PCT/EP2014/072561, having a filing date of Oct. 21, 2014, based off of German application No. DE 102013226802.5 having a filing date of Dec. 20, 2013, the entire contents of which are hereby incorporated by reference.

### FIELD OF TECHNOLOGY

The following relates to the technical field of the protection of privacy in video streams.

### BACKGROUND

H.264 describes an ITU-T standard for compressing video data and is described with the same wording in ISO/IEC 14496-10 (AVC).

HEVC describes a further standard for compressing video data and is described in ISO/IEC 23008-2.

AVC is the name at ISO and stands for Advanced Video Coding. HEVC is likewise the name at ISO and stands for High Efficiency Video Coding.

It is known that a video stream can comprise a slice structure, which is the case in AVC and HEVC, for example. A slice is usually used to structure the data of the video stream. A slice is typically a detail from an image.

There are numerous situations in which the protection of privacy in video streams is desirable. It may be advisable when monitoring a terrain or building by means of video camera to protect image details that show public space against unauthorized monitoring. Similarly, there are situations in which faces of persons who move in an area monitored by a video camera need to be disguised.

On the one hand, decoder-end solutions are known. However, most of these do not provide adequate protection, since the content of the video stream obtains in unprotected form at least at the input of the decoder.

These decoder-end methods involve original streams being decoded, for example in the decoder, and the regions to be protected being faded out, for example by blackening or distorting them, so that they no longer show content relevant to privacy when displayed on a screen. The resulting video streams are in turn encoded in a complex manner by a further encoder and stored. In this way, the decoder adds in measures for protecting privacy in the image region and the streams that are in turn encoded by the decoder are stored in the video management system of the monitoring installation. The restriction of access rights means that only particular users are able to present the video streams without protection of privacy, while other users are able to present the video streams with protection of privacy applied. A disadvantage of decoder-end solutions is also that multiple, predominantly identical video streams need to be stored, and that the videos without the application of measures for protecting privacy require special handling appropriate to the sensitive content.

On the other hand, further known measures involve selective encryption in the encoder. Most of these methods require profound integration into the video encoder. In this case, one main application is the reduction of the overall quality of the video in order to protect paid content. The benefit for protection of privacy is questionable in this case, however. In order to obtain standard compliance, only very few syntax elements are left to which the encryption can be applied, which is problematic particularly when context adaptive binary arithmetic coding (CABAC) is used. Selective encryption in the encoder also requires restrictions for the encoding modes used to be tolerated, or the presence of special features in the encoder, such as flexible macroblock ordering (FMO), for example, is a prerequisite. However, these known methods have the disadvantage that measures for protecting privacy necessitate adaptation of the encoder and decoder.

Both decoder-end and encoder-end methods usually have the disadvantage that measures for protecting privacy are applied to the entire content of the video stream, since signaling to limit standardized measures to particular image regions has not been known to date.

### SUMMARY

Therefore, the present embodiments of the invention are based on the aspect of simplifying the implementation of protection of privacy in a video stream.

According to one aspect, a method for protecting a privacy is proposed. This involves a video stream being produced. The video stream comprises a slice structure. A slice of the video stream that comprises content to be protected is identified. A slice that is at least partially redundant in relation to the identified slice is produced, so that two at least partially redundant slices are obtained. The content to be protected in one of the two slices is encrypted. In the other slice, at least one measure to ensure privacy is applied to the content to be protected.

According to a further aspect, an apparatus for protecting privacy in a video stream is presented. The video stream comprises a slice structure. The apparatus comprises an identification means, a production means, an encryption means and a privacy means. The identification means is adapted to identify a slice of the video stream that comprises content to be protected. The production means is adapted to produce a slice that is at least partially redundant in relation to the identified slice, so that two at least partially redundant slices are obtained. The encryption means is adapted to encrypt the content to be protected in one of the two slices. The privacy means is adapted to apply at least one measure to ensure privacy to the content to be protected in the other of the two slices.

### BRIEF DESCRIPTION

Some of the embodiments will be described in detail, with reference to the following figures, wherein like designations denote like members, wherein:

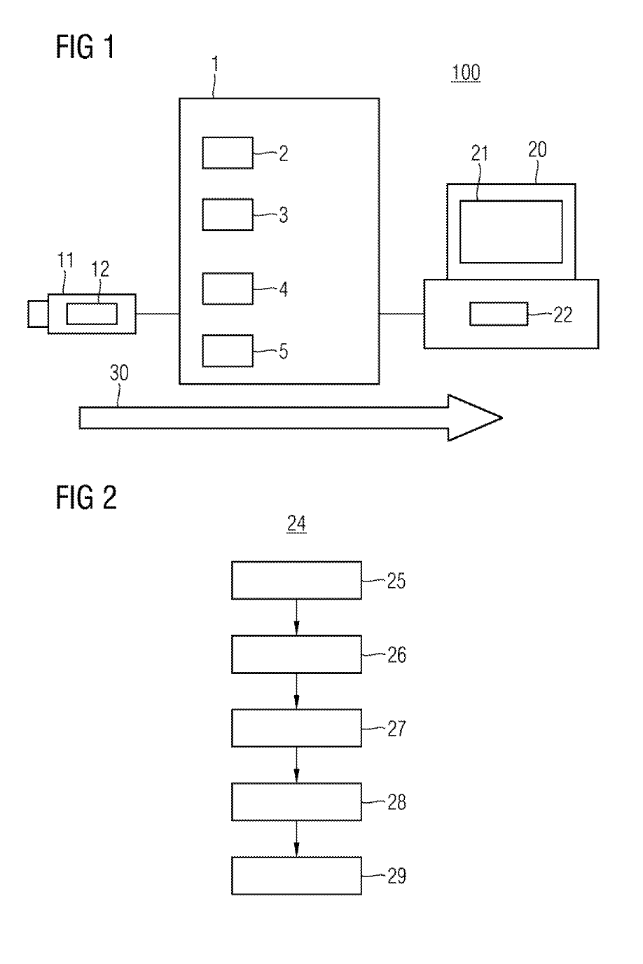

FIG. 1 shows a block diagram of a system that comprises an apparatus for protecting privacy in a video stream;

FIG. 2 shows a flowchart for a method according to an exemplary embodiment of the invention;

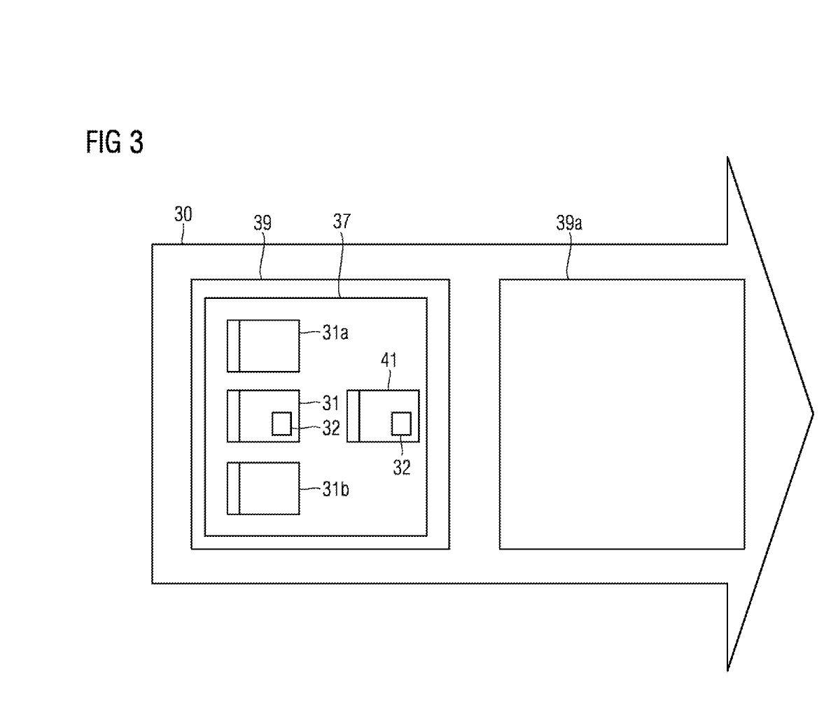

FIG. 3 shows a diagram of an exemplary video stream that comprises an exemplary slice structure that can be implemented in preferred exemplary embodiments, for example in the exemplary embodiments described with reference to FIG. 1 and/or FIG. 2;

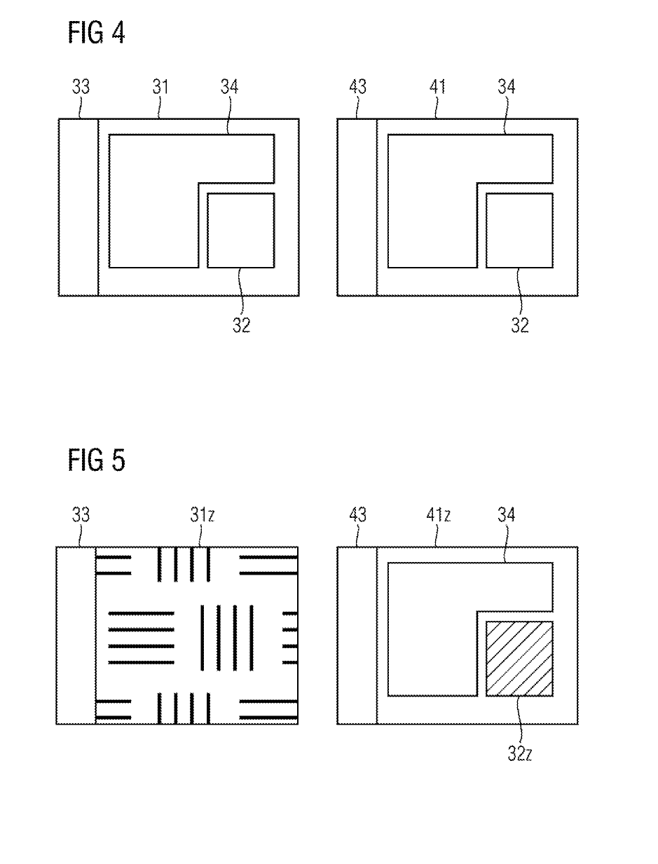

FIG. 4 shows a diagram of two slices of the slice structure from FIG. 3 in one method step of a method; and

FIG. 5 shows a further diagram of the two slices from FIG. 4 in another method step.

### DETAILED DESCRIPTION

FIG. 1 shows a system 100 in the form of a network for transmitting and protecting a video stream 30. The system 100 comprises a video camera 11, an apparatus 1 for protecting privacy and a display means 20, for example a personal computer. The video camera 11 comprises an encoder 12. The display means 20 comprises a screen 21 and a decoder 22. The encoder 12 and the decoder 22 may also be embodied as separate appliances, that is to say appliances that are not integrated in the video camera 11 or in the display means 20. The video stream 30 flows from the encoder 12 via the apparatus 1 to the decoder 22, and is preferably compressed on this path.

The apparatus 1 for protecting privacy comprises an identification means or device 2, a production means or device 3, an encryption means or device 4 and privacy means or device 5. The identification means 2 is adapted to identify a slice 31 of a video stream 30 that comprises content 32 to be protected. The production means 3 is adapted to produce a slice 41 that is at least partially redundant in relation to the identified slice 31, so that two at least partially redundant slices 31, 41 are obtained. The encryption means 4 is adapted to encrypt the content 32 to be protected in one of the two slices 31, 41. The privacy means 5 is adapted to apply at least one measure to ensure privacy to the content 32 to be protected in the other 41, 31 of the two slices 31, 41.

FIG. 2 shows a flowchart for a method 24 according to an exemplary embodiment of the invention. The system 100 is preferably adapted to perform the method 24. The exemplary method 24 is used to protect privacy. The method involves a video stream 30 being produced in method step 25. The video stream 30 comprises a slice structure 37. In method step 26, a slice 31 of the video stream 30 that comprises content 32 to be protected is identified. Content to be protected is privacy-relevant content, for example. In method step 27, a slice 41 that is at least partially redundant in relation to the identified slice 31 is produced, so that two at least partially redundant slices 31, 41 are obtained. In method step 28, the content 32 to be protected in one of the two slices 31, 41 is encrypted. In method step 29, at least one measure to ensure privacy is applied to the content 32 to be protected in the other 41, 31 of the two slices. It is irrelevant to embodiments of the invention whether method step 28 is performed before, after or at the same time as method step 29. It is also irrelevant which of the two redundant slices 31, 41 is encrypted, and to which of them the measure to ensure privacy is applied.

Preferably, the method is performed for multiple slices that comprise content to be protected. By way of example, according to a preferred embodiment, each slice of the video stream 30 that comprises a content to be protected is identified as part of a method step 26. For each of these identified slices, a respective at least partially redundant slice is produced, so that slice pairs each having two at least partially redundant slices are obtained. For each of the slice pairs, respective method steps 27-29 are performed.

Preferably, the method is performed only for slices that comprise content to be protected. In this case, the video stream 30 thus contains at least one slice that comprises no content to be protected, and for which no redundant slice is produced.

FIG. 3 shows an example of the preferably compressed video stream 30 shown in FIG. 1 that runs from the video camera 11 via the interposed apparatus 1 to the display unit 20, at an increased level of detail. The video stream 30 can comprise multiple images 39, 39a for example. The video stream 30 comprises a slice structure 37, as can be seen in image 39. The slice structure 37 comprises multiple slices 31, 31a, 31b, 41. According to preferred exemplary embodiments, the slices 31 and 41 are at least partially redundant and comprise the content 32 to be protected, and also content 34 that does not need to be protected.

FIG. 4 shows the two slices 31, 41 of the slice structure 37 from FIG. 3 at an increased level of detail immediately after method step 27, but before method steps 28 and/or 29 are performed. According to the preferred embodiment illustrated using FIG. 4, the at least partially redundant slice 41 is produced by the production means 3 in a manner that is totally redundant in relation to the identified slice 31, so that two completely redundant slices 31, 41 are obtained.

Additionally, the two slices 31, 41 are each identifiable by means of a flag 33, 43 in the video stream 30, the flags 33, 43 preferably not being encrypted later in the process so that the two slices 31, 41 are still identifiable following the encryption without increased effort. The flags 33, 43 furthermore allow direct access to the slices, which is advantageous for the packetization in the case of relevant transmission methods or for the organization of the memory space in the case of the decoding, inter alia.

FIG. 5 shows the two slices 31, 41 after method steps 28 and 29 according to preferred embodiments have been performed. In the exemplary embodiment shown in FIG. 5, the slice 31 has been completely encrypted by the encryption means 4, resulting in the completely encrypted—with the exception of the flag 33—slice 31z. In addition, in the exemplary embodiment illustrated using FIG. 5, the content 32 to be protected in the slice 41 has been blackened and hence disguised by the privacy means 5. This results in the slice 41z with the blackened content 32z and the unaltered content 34. The blackening of the content to be protected is an example of a measure to ensure privacy for the content 32 to be protected. Further examples are various types of distortion of the content by means of filtering, e.g. low pass filters or blurring.

Preferably, the at least partially redundant slice 41 is produced in the video stream 30, so that two at least partially redundant slices 31, 41 are obtained in the video stream 30. According to preferred exemplary embodiments, the encoding of the video is also included. By way of example, the slice structure is, according to one exemplary embodiment, embodied such that the content to be protected is comprised by the identified slice. In other words: the structuring of the content into slices can thus be effected such that the region to be protected (e.g. the visible part of the road) is combined in one slice. This makes protection of privacy easier because only one slice needs to be duplicated.

Preferably, the video stream 30 is a compressed video stream and/or the at least partially redundant slice 41 is produced in the compressed video stream 30. In other words: first of all, the encoder 12 of the video camera 11, for example, produces a compressed video stream and, at a later time, the encryption means 4 encrypts the content 32 to be protected in one of the two slices 31, 41. Since encrypted data are normally compressible to less of an extent, this allows the compression rate to be increased.

Preferably, the compressed video stream in which privacy protection is performed is an AVC video stream.

According to preferred embodiments of the invention, an at least partially redundant slice 41 is produced in the compressed video for that slice 31 in the original image in which the measure is intended to be applied to the content to be protected. The original content in the slice 31 is rendered illegible by means of encryption. As a result, the decoder 22 is prompted to decode the redundant slice 41. In the redundant slice 41, the regions 32 to be protected are blackened or disguised.

The regions 32 that need to be protected are altered in the redundant slice in accordance with the chosen method. The original slice 31 is e.g. encrypted. This method works independently of the video encoder 12 and decoder 22.

At the end of the method 24, an encoded video is obtained that contains both components 32, 34, and any available decoder 22 would display exclusively the video in which the measures are applied.

The encryption of the original slice 31 means that no further special treatment of the content to be protected is required. The original slice can be represented again only if the key is known.

Preferred embodiments of the invention solve the following problems:
privacy protection in AVC video streams;
privacy protection without the involvement of the encoder;
privacy protection without the involvement of the decoder/display unit;
retention of the undistorted AVC original stream for preservation of evidence;
use of commercially available decoders in order to view the video inclusive of privacy protection;
use of commercially available decoders in order to present the original video;
use of commercially available encoders for compressing the video stream.

Preferred embodiments of the invention are distinguished by the following advantages:
According to the AVC standard, an AVC decoder 22 automatically uses the unencrypted slice. By way of example, an AVC decoder 22 uses the redundant slice 41 if the original slice 31 is undecodable on account of encryption. The redundant slice comprises the regions that are protected by means of privacy protection.
According to the AVC standard, an AVC decoder 22 automatically uses the original slice 31 it obtains in decrypted form, and the redundant slice is ignored in this case.
Preferred embodiments of the method 24 and of the apparatus 1 operate in the “compressed domain” realm and can be applied independently of an AVC encoder.
The method can be applied independently of an AVC decoder.
Only authorized persons with access to the appropriate keys are capable of viewing the content 32 to be protected.
Two versions of the video stream are not produced, which results in a memory space reduction.

1. A method for protecting a privacy, comprising the method steps of:
producing of a video stream that includes a slice structure;
identifying a slice of the video stream that includes content to be protected;
producing a slice that is at least partially redundant in relation to the identified slice, so that two at least partially redundant slices are obtained;
encrypting the content to be protected in one of the two slices, and applying at least one measure to ensure privacy to the content to be protected in the other of the two slices.

2. The method as claimed in claim 1, wherein the content to be protected in one of the two slices is encrypted by encrypting the entire one of the two slices.

3. The method as claimed in claim 1, wherein the two slices are each identifiable by a flag in the video stream, wherein the flags are not encrypted.

4. The method as claimed in claim 1, wherein the video stream is a compressed video stream.

5. The method as claimed in claim 1, wherein the at least partially redundant slice is produced in the compressed video stream.

6. The method as claimed in claim 1, wherein the at least partially redundant slice is completely redundant in relation to the identified slice.

7. The method as claimed in claim 1, wherein the at least one measure to ensure privacy comprises disguise of the content to be protected, by blackening of the content to be protected.

8. The method as claimed in claim 1, wherein the at least partially redundant slice is produced in the video stream, so that two at least partially redundant slices are obtained in the video stream.

9. The method as claimed in claim 1, wherein the slice structure is embodied such that the content to be protected is comprised by the identified slice.

10. An apparatus for protecting privacy in a video stream that comprises a slice structure, said apparatus comprising:
an identification device that is adapted to identify a slice of the video stream that comprises content to be protected;
a production device that is adapted to produce a slice that is at least partially redundant in relation to the identified slice, so that two at least partially redundant slices is obtained;
an encryption device that is adapted to encrypt the content to be protected in one of the two slices;
a privacy device that is adapted to apply at least one measure to ensure privacy to the content to be protected in the other of the two slices.

11. The apparatus as claimed in claim 10, wherein the encryption device is adapted to encrypt the entire one of the two slices.

12. The apparatus as claimed in claim 10, wherein the two slices are each identifiable by means of a flag in the video stream, wherein the flags are unencrypted.

13. The apparatus as claimed in claim 10, wherein the video stream is a compressed video stream.

14. The apparatus as claimed in claim 13, wherein the apparatus is adapted to produce the at least partially redundant slice in the compressed video stream.

15. The apparatus as claimed in claim 10, wherein the production device is adapted to produce the at least partially redundant slice completely redundantly in relation to the identified slice.

16. The apparatus as claimed in claim 10, wherein the privacy means is adapted to disguise the content to be protected, by blackening the content to be protected.

17. The apparatus as claimed in claim 10, wherein the apparatus is adapted to produce the at least partially redundant slice in the video stream, so that two at least partially redundant slices are obtained in the video stream.

18. The apparatus as claimed in claim 10, wherein the slice structure is embodied such that the content to be protected is comprised by the identified slice.
